(19) United States
(12) Patent Application Publication
(10) Pub. No.: US 2025/0289751 A1
(43) Pub. Date: Sep. 18, 2025

(54) CHEMICALLY TEMPERED CRYSTALLIZED GLASS, AND CRYSTALLIZED GLASS TO BE CHEMICALLY TEMPERED

(71) Applicant: AGC Inc., Tokyo (JP)

(72) Inventor: Kaname SEKIYA, Tokyo (JP)

(73) Assignee: AGC Inc., Tokyo (JP)

(21) Appl. No.: 19/076,530

(22) Filed: Mar. 11, 2025

(30) Foreign Application Priority Data
Mar. 15, 2024 (JP) 2024-041329

(51) Int. Cl. C03C 21/00; C03C 3/083

(52) U.S. Cl. CPC C03C 21/003; C03C 3/083

(57) ABSTRACT

The object of the present invention is to provide novel glass. Chemically tempered crystallized glass obtained by chemically tempering crystallized glass to be chemically tempered, wherein the absolute value of the maximum voltage measured is 1950 V or more when corona discharge is generated under a voltage applied of 10 kV and the chemically tempered crystallized glass is charged for 30 seconds, measured by a static honest meter.

### TECHNICAL FIELD

The present invention relates to chemically tempered crystallized glass obtained by chemically tempering crystallized glass to be chemically tempered, and crystallized glass to be chemically tempered.

### BACKGROUND ART

In recent years, cover glass has been used for the purpose of protecting and improving appearance of display devices such as mobile phones, smartphones and tablet devices. The cover glass for such purposes has been required to have excellent strength to suppress breakage due to e.g. impact.

Further, such cover glass may also be used for protection of e.g. solar cell modules.

Heretofore, it has been known to increase surface strength of glass by means of chemical tempering treatment by soaking glass e.g. in molten potassium nitrate.

For example, Patent Document 1 discloses to conduct chemical tempering treatment by soaking glass in molten potassium nitrate to improve surface strength of the obtainable glass plate. More specifically, it discloses that the strength of a glass plate improves by conducting chemical tempering treatment on glass containing Li with a molten salt containing Na and then with a molten salt containing K. It also discloses that the mechanism how a glass plate is strengthened by such chemical treatment is due to compressive stress that occurs by exchange of alkali metals. Patent Document 1 also discloses use of crystallized glass having crystals precipitated in glass, as glass to be chemically tempered.

### PRIOR ART DOCUMENTS

### Patent Documents

Patent Document 1: WO2022-215575

### DISCLOSURE OF INVENTION

### Technical Problem

In recent years, as the variety of devices is increasing, novel glass having various properties has been desired.

Under these circumstances, the object of the present invention is to provide novel glass with properties not achieved by conventional glasses.

### Solution to Problem

The present inventors have conducted extensive studies on the above object and as a result found chemically tempered crystallized glass wherein the voltage as measured by a static honest meter is equal to or more than a predetermined value, and accomplished the present invention.

That is, the present inventors have found that the above object can be achieved by the following construction.
[1] Chemically tempered crystallized glass obtained by chemically tempering crystallized glass to be chemically tempered, wherein the absolute value of the maximum voltage measured is 1950 V or more when corona discharge is generated under a voltage applied of 10 KV and the chemically tempered crystallized glass is charged for 30 seconds, measured by a static honest meter.
[2] The chemically tempered crystallized glass according to [1], wherein the crystallized glass to be chemically tempered has a composition as represented by mole percentage based on oxides comprising:
   SiO₂: 60 to 75%,
   Al₂O₃: 3 to 20%,
   P₂O₅: 0 to 5%,
   Li₂O: 6 to 23%,
   Na₂O: 0 to 5%,
   K₂O: 0 to 5%,
   MgO: 0 to 10%,
   CaO: 0 to 5%, and
   ZrO₂: 0 to 5%.
[3] The chemically tempered crystallized glass according to [1] or [2], which contains a crystal selected from the group consisting of Li₃PO₄, Li₂SiO₃, Li₂Si₂O₅, LiAISi₄O₁₀ and LiAISi₂O₆ crystals.
[4] The chemically tempered crystallized glass according to any one of [1] to [3], wherein the absolute value of the maximum voltage measured is 2250 V or less.
[5] The chemically tempered crystallized glass according to any one of [1] to [4], which has a fracture toughness K_{IC} of 0.90 MPa·m^{1/2} or more.
[6] The chemically tempered crystallized glass according to any one of [1] to [5], which has a Young's modulus of 85 GPa or more.
[7] The chemically tempered crystallized glass according to any one of [1] to [6], wherein the average value of the tensile stress CTₐᵥₑ of the crystallized glass to be chemically tempered is 95 MPa or more.
[8] The chemically tempered crystallized glass according to any one of [1] to [7], wherein the maximum value of the tensile stress CT_{Max} of the crystallized glass to be chemically tempered is 100 MPa or more.
[9] The chemically tempered crystallized glass according to any one of [1] to [8], which satisfies the following formula (I):

$$C {S}_{90} ≧ 0.2 t - 10 \qquad formula ( I )$$

in the formula (I), CS₉₀ is the compressive stress at a depth of 90 μm from the surface of the chemically tempered crystallized glass, where the unit is MPa; and
in the formula (I), t is the plate thickness of the chemically tempered crystallized glass, where the unit is μm.
[10] The chemically tempered crystallized glass according to any one of [1] to [9], wherein the depth of compressive stress layer DOC is 0.17 to 0.25 times the plate thickness of the chemically tempered crystallized glass, where the unit of the depth of compressive stress layer and the unit of the plate thickness of the chemically tempered crystallized glass are μm.
[11] The chemically tempered crystallized glass according to any one of [1] to [10], wherein the water contact angle is 80° or more, after an antifouling layer containing a fluorinated compound is formed on one side of the chemically tempered crystallized glass, and rubber rubbing test is conducted on the surface of the chemically tempered crystallized glass on which the antifouling layer is formed, under a load of 9.8N for 2500 cycles.
[12] Crystallized glass to be chemically tempered, wherein the absolute value of the maximum voltage measured is 1200 V or more when corona discharge is generated under a voltage applied of 10 KV and the crystallized glass to be chemically tempered is charged for 30 seconds, measured by a static honest meter.
[13] The crystallized glass to be chemically tempered according to [12], which has a composition as represented by mole percentage based on oxides comprising:
   SiO₂: 60 to 75%,
   Al₂O₃: 3 to 20%,
   P₂O₅: 0 to 5%,
   Li₂O: 6 to 23%,
   Na₂O: 0 to 5%,
   K₂O: 0 to 5%,
   MgO: 0 to 10%,
   CaO: 0 to 5%, and
   ZrO₂: 0 to 5%.
[14] The crystallized glass to be chemically tempered according to or [13], which contains a crystal selected from the group consisting of LisPO₄, LizSiO₃, Li₂Si₂O₅, LiAISi₄O₁₀ and LiAISi₂O₆ crystals.
[15] The crystallized glass to be chemically tempered according to any one of to [14], which has a fracture toughness K_{IC} of 0.90 MPa·m^{1/2} or more.
[16] The crystallized glass to be chemically tempered according to any one of to [15], which has a Young's modulus of 85 GPa or more.

### Advantageous Effects of Invention

According to the present invention, it is possible to provide novel glass.

### BRIEF DESCRIPTION OF DRAWINGS

FIG. 1 is a diagram illustrating a sample used for measurement of the fracture toughness K_{IC} by DCDC method.

FIG. 2 is a diagram illustrating a K1-v curve indicating the relation between the stress intensity factor K1 (unit: MPa·m^{1/2}) and the crack growth rate v (unit: m/s), used for measurement of the fracture toughness K_{IC} by DCDC method.

### DESCRIPTION OF EMBODIMENTS

Now, the chemically tempered crystallized glass of the present invention will be described in detail. It should be understood that the present invention is no means restricted to the following embodiments, and various modifications are possible within the scope of the invention.

In this specification, “chemically tempered crystallized glass” means crystallized glass to which chemical tempering treatment has been applied. “Crystallized glass to be chemically tempered” means crystallized glass to which chemical tempering treatment has not been applied.

In this specification, the glass composition of the crystallized glass to be chemically tempered may sometimes be referred to as the base glass composition of the chemically tempered crystallized glass. The chemically tempered crystallized glass usually has a compressive stress layer formed by ion exchange on the glass surface portion, and thus its glass composition of a portion not ion-exchanged agrees with the base glass composition of the chemically tempered crystallized glass.

In this specification, the glass composition is represented by mole percentage based on oxides and mol % may sometimes be referred to simply as %. “to” used to show the range of numerical values is used to include the numerical values before and after it as the lower limit value and the upper limit value.

The glass composition “containing substantially no” means that the glass does not contain the mentioned component excluding inevitable impurities contained in the raw materials or the like, that is, the mentioned component is not intentionally contained. Specifically, the content of components other than ones described in the glass composition is preferably for example less than 0.1 mol %, more preferably 0.08 mol % or less, further preferably 0.05 mol % or less.

In this specification, the “stress profile” is a patter indicating the compressive stress that varies with respect to the depth from the glass surface. A negative compressive stress means a tensile stress.

In this specification, “the stress profile” may be obtained by a method using a scattered light photoelectric stress meter.

By the method using a scattered light photoelectric stress meter, the stress can be measured regardless of refractive index distribution that occurs from the surface toward the inside of the chemically tempered glass. As the scattered light photoelectric stress meter, SLP2000 manufactured by Orihara Industrial Co, Ltd. may, for example, be used.

In this specification, the depth of compressive stress layer is the depth at which the compressive stress becomes zero.

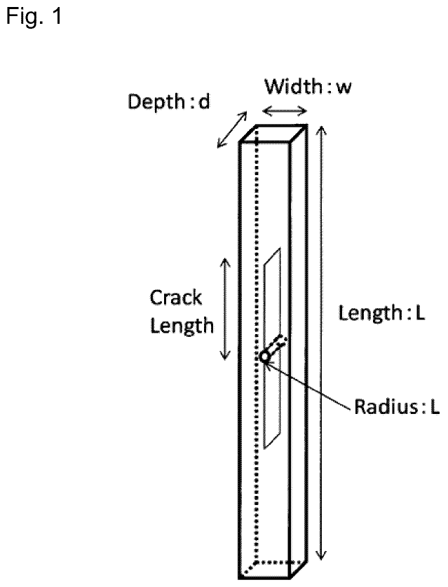

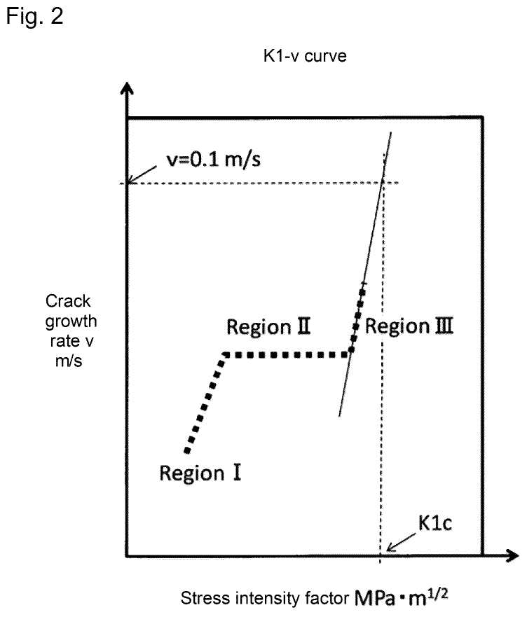

In this specification, the “fracture toughness K_{IC}” is measured with reference to DCDC method [reference: M. Y. He, M. R. Turner and A. G. Evans, Acta Metall. Mater. 43 (1995) 3453]. Specifically, using a sample of a shape as shown in FIG. 1 and autograph AGS-X5KN manufactured by SHIMADZU CORPORATION, a K1-v curve indicating the relation between the stress intensity factor K1 (unit: MPa·m^{1/2}) and the crack growth rate v (unit: m/s) is obtained as shown in FIG. 2, and the data regarding Region III obtained is subjected to regression by a linear expression and extrapolation, and the stress intensity factor K1 at 0.1 m/s is taken as the fracture toughness K_{IC}.

### <Chemically Tempered Crystallized Glass>

The chemically tempered crystallized glass of the present invention is obtained by chemically tempering the crystallized glass to be chemically tempered.

The chemically tempered crystallized glass of the present invention is such that the absolute value of the maximum voltage measured is 1950 V or more when corona discharge is generated under a voltage applied of 10 kV and the chemically tempered crystallized glass is charged for 30 seconds, measured by a static honest meter.

Now, the chemically tempered crystallized glass of the present invention will be described.

### [Maximum Voltage Measured]

The chemically tempered crystallized glass of the present invention is such that the absolute value of the maximum voltage measured is 1950 V or more when corona discharge is generated under a voltage applied of 10 KV and the chemically tempered crystallized glass is charged for 30 seconds, measured by a static honest meter.

Now, measurement of the maximum voltage will be described in detail.

In the present invention, as the static honest meter, static honest meter (H0110-S4) manufactured by SHISHIDO ELECTROSTATIC, LTD. is used.

Measurement is conducted at a temperature of 22 to 25° C. under a relative humidity of 47 to 55%.

The static honest meter includes a turn table to hold a measurement sample, an application unit connected to a high pressure direct current power supply to generate corona discharge, and a receiving unit to measure the potential of the measurement sample.

The turn table has a test specimen attachment frame to hold the measurement sample so that a part of the measurement sample is exposed to the surface.

A 45 mm×45 mm measurement sample is cut out from the chemically tempered crystallized glass.

The measurement sample is fixed to the test specimen attachment frame on the turn table. Then, the height of the application unit is adjusted so that the distance between the frame surface of the test specimen attachment frame to the tip of a needle electrode of the application unit is 18 mm. Further, the height of the receiving unit is adjusted so that the distance between the frame surface of the test specimen attachment frame to an electrode of the receiving unit is 13 mm.

Then, static electricity is removed from the measurement sample by an antistatic apparatus.

While the turn table is rotated, corona discharge is generated under a voltage applied of 10 kV to charge the measurement sample. The charging time is 30 seconds.

The maximum value of the voltage measured by the receiving unit during charging, is recorded as the maximum voltage measured (unit: V).

The above measurement is conducted with respect to five measurement samples, and the arithmetic mean of the obtained maximum voltages measured is taken as the maximum voltage measured of the chemically tempered crystallized glass.

The chemically tempered crystallized glass of the present invention is such that the absolute value of the maximum voltage measured is 1950 V or more, preferably 1960 V or more. The absolute value of the maximum voltage measured is preferably 2250 V or less, more preferably 2200 V or less, further preferably 2100 V or less, particularly preferably less than 2070 V, whereby an antifouling layer, when formed on the surface of the chemically tempered crystallized glass, will be less likely to be separated.

According to the studies by the present inventors, it was found that the surface resistance of the chemically tempered crystallized glass tends to be higher when the absolute value of the maximum voltage measured is higher.

According to the studies by the present inventors, the relation between abnormal emission at the edge portion and the surface resistance of an organic electroluminescent display (OLED) was further found.

Specifically, when the chemically tempered crystallized glass is used as a cover glass, due to repeated contact e.g. with fingers, charge may be accumulated on the surface of e.g. the cover glass. It is considered as follows. That is, the accumulated charge is less likely to move in the in-plane direction when the surface resistance of the chemically tempered crystallized glass is high. Thus, the surface resistance of the glass tends to increase and resultingly the absolute value of the maximum charge voltage becomes higher than a predetermined value, whereby the charge accumulated at the edge portion of the screen is less likely to be supplied. Then, the abnormal emission of the OLED is suppressed.

### [Compressive Stress]

The chemically tempered crystallized glass of the present invention has a compressive stress layer in which compressive stress occurs, on its surface side, in many cases. Now, preferred parameters relating to the compressive stress will be described.

The compressive stress (CS₀) at the outermost portion of the chemically tempered crystallized glass of the present invention is preferably 150 MPa or more, more preferably 200 MPa or more, further preferably 300 MPa or more, particularly preferably 400 MPa or more. CS₀ of the chemically tempered crystallized glass of the present invention is 1500 MPa or less in many cases, and is preferably 1200 MPa or less, more preferably 1100 MPa or less, further preferably 1000 MPa or less.

CS₀ of the chemically tempered crystallized glass of the present invention is measured by the above described scattered light photoelectric stress meter.

The compressive stress (CS₅₀) at a depth of 50 μm of the chemically tempered crystallized glass of the present invention is preferably 40 MPa or more, more preferably 80 MPa or more, further preferably 120 MPa or more, whereby the chemically tempered crystallized glass will be less likely to have a crack even if subjected to a greater impact when another object hits the chemically tempered crystallized glass of the present invention. CS₅₀ of the chemically tempered crystallized glass of the present invention is 500 MPa or less in many cases, and is preferably 300 MPa or less, more preferably 250 MPa or less, further preferably 200 MPa or less, particularly preferably 180 MPa or less, whereby the compressive stress will not exceed the CT limit of the glass,

The compressive stress (CS₉₀) at a depth of 90 μm of the chemically tempered crystallized glass of the present invention is preferably −10 MPa or more, more preferably 10 MPa or more, further preferably 30 MPa or more, whereby the chemically tempered crystallized glass will be less likely to have a crack even if subjected to a greater impact when another object hits the chemically tempered crystallized glass of the present invention. CS₉₀ of the chemically tempered crystallized glass of the present invention is 200 MPa or less in many cases, and is preferably 180 MPa or less, more preferably 150 MPa or less, further preferably 120 MPa or less, whereby the compressive stress will not exceed the CT limit of the glass.

The compressive stress at each depth may be calculated from the stress profile obtained by the above method.

The depth of compressive stress layer (DOC) of the chemically tempered crystallized glass of the present invention is preferably 80 μm or more, more preferably 90 μm or more, further preferably 100 μm or more. DOC of the chemically tempered crystallized glass of the present invention is preferably 180 μm or less, more preferably 150 μm or less, further preferably 120 μm or less.

The product (CSₐᵣₑₐ) of CS₀ and DOC of the chemically tempered crystallized glass of the present invention is 15000 Pa·m or more in many cases, and is preferably 20000 Pa·m or more, more preferably 40000 Pa·m or more, further preferably 60000 Pa·m or more. CSₐᵣₑₐ of the chemically tempered crystallized glass of the present invention is 200000 Pa·m or less in many cases, and is preferably 180000 Pam or less, more preferably 160000 Pa·m or less.

Regarding DOC of the chemically tempered crystallized glass of the present invention, it is also preferred that DOC is 0.17 to 0.25 times the plate thickness of the chemically tempered crystallized glass of the present invention. That is, it is also preferred that a value obtained by dividing DOC (unit: μm) of the chemically tempered crystallized glass of the present invention by the plate thickness (unit: μm) is 0.17 to 0.25.

Regarding CS₉₀ and the plate thickness of the chemically tempered crystallized glass of the present invention, it is also preferred that the following formula (I) is satisfied.

$$C {S}_{90} ≧ 0.2 t - 10 \qquad formula ( I )$$

In the formula (I), CS₉₀ is the compressive stress at a depth of 90 μm from the surface of the chemically tempered crystallized glass, where the unit is MPa.

In the formula (I), t is the plate thickness of the chemically tempered crystallized glass, where the unit is μm.

When the formula (I) is satisfied, the value obtained by subtracting the right-hand side value of the formula (I) from the left-hand side value is a positive value, and the subtracted value is preferably 10 or more, more preferably 15 or more, further preferably 20 or more. The subtracted value is 100 or less in many cases, and is preferably 50 or less.

### [Tensile Stress]

The chemically tempered crystallized glass of the present invention has a compressive stress layer on its surface in many cases, and in such cases, a tensile stress that balances with the compressive stress occurs inside the chemically tempered crystallized glass.

Now, preferred parameters relating to the tensile stress will be described.

The maximum value (CT_{Max}) of the tensile stress of the chemically tempered crystallized glass of the present invention is preferably 40 MPa or more, more preferably 50 MPa or more, further preferably 70 MPa or more, particularly preferably 100 MPa or more. Further, CT_{Max} of the chemically tempered crystallized glass of the present invention is 250 MPa or less in many cases, and is preferably 180 MPa or less, more preferably 150 MPa or less, further preferably 120 MPa or less.

CT_{Max} is obtained from the stress profile and usually occurs at the center portion in the thickness direction of the plate.

The average value (CTₐᵥₑ) of the tensile stress of the chemically tempered crystallized glass of the present invention is preferably 30 MPa or more, more preferably 40 MPa or more, further preferably 50 MPa or more, particularly preferably 60 MPa or more. CTₐᵥₑ of the chemically tempered crystallized glass of the present invention is 200 MPa or less in many cases, and is preferably 140 MPa or less, more preferably 120 MPa or less.

The average value of the tensile stress is obtained by dividing an integrated value of the tensile stress in the plate thickness direction in a region with a depth at which the tensile stress occurs in the stress profile, by the length of the tensile stress portion.

The integrated value (ICT) of the tensile stress of the chemically tempered crystallized glass of the present invention is 60000 Pa·m or less in many cases, and is preferably 50000 Pa·m or less, more preferably 40000 Pa·m or less, further preferably 30000 Pa·m or less. The lower limit of ICT is not particularly limited and is 10000 Pa·m or more in many cases, and is preferably 20000 Pa·m or more.

ICT is obtained by integrating the tensile stress in a region with a depth at which the tensile stress occurs.

### [Plate Thickness]

The plate thickness of the chemically tempered crystallized glass of the present invention may optionally be adjusted depending upon the application and is 0.1 mm or more in many cases, and is preferably 0.2 mm or more, more preferably 0.3 mm or more, further preferably 0.4 mm or more. The plate thickness of the chemically tempered crystallized glass of the present invention is 2.0 mm or less in many cases, and is preferably 1.5 mm or less, more preferably 1.2 mm or less, further preferably 1.0 mm or less.

### [Physical Properties]

The fracture toughness K_{IC} of the chemically tempered crystallized glass of the present invention is preferably 0.80 MPa·m^{1/2} or more, more preferably 0.85 MPa·m^{1/2} or more, further preferably 0.90 MPa·m^{1/2} or more, particularly preferably 1.0 MPa·m^{1/2} or more, most preferably 1.1 MPa·m^{1/2} or more. The upper limit of the fracture toughness K_{IC} is not particularly limited and is typically 1.6 MPa·m^{1/2} or less.

The fracture toughness K_{IC} of chemically tempered crystallized glass usually agrees with the fracture toughness K_{IC} of the crystallized glass to be chemically tempered.

The Young's modulus of the chemically tempered crystallized glass of the present invention is preferably 80 GPa or more, more preferably 85 GPa or more, further preferably 90 GPa or more, particularly preferably 95 GPa or more, most preferably 100 GPa or more. The upper limit of the Young's modulus is not particularly limited and is typically 120 GPa or less.

The Young's modulus of chemically tempered crystallized glass usually agrees with the Young's modulus of the crystallized glass to be chemically tempered.

### [Composition]

The chemically tempered crystallized glass of the present invention is obtained by chemically tempering plate glass (crystallized glass to be chemically tempered) that has not been chemically tempered.

The glass composition of the crystallized glass to be chemically tempered agrees with the composition at the center portion in the plate thickness direction of the chemically tempered crystallized glass. That is, a preferred composition at the center portion in the plate thickness direction of the chemically tempered crystallized glass agrees with a preferred composition of the crystallized glass to be chemically tempered.

The crystallized glass to be chemically tempered preferably has a composition as represented by mole percentage based on oxides comprising:
SiO₂: 60 to 75%,
Al₂O₃: 3 to 20%,
P₂O₅: 0 to 5%,
Li₂O: 6 to 23%,
Na₂O: 0 to 5%,
K₂O: 0 to 5%,
MgO: 0 to 10%,
CaO: 0 to 5%, and
ZrO₂: 0 to 5%.

A more preferred composition of the crystallized glass to be chemically tempered, a process for producing the crystallized glass to be chemically tempered, etc., will be described in detail later.

The crystal which the crystallized glass to be chemically tempered contains is also contained in the chemically tempered crystallized glass, and a preferred embodiment of the crystal contained in the chemically tempered crystallized glass is the same as a preferred embodiment of the crystal contained in the crystallized glass to be chemically tempered.

That is, the chemically tempered crystallized glass preferably contains at least one crystal selected from the group consisting of Li₃PO₄, Li₂SiO₃, Li₂Si₂O₅, LiAlSi₄O₁₀ and LiAISi₂O₆ crystals.

### [Chemical Tempering Treatment]

As described above, the chemically tempered crystallized glass of the present invention is obtained by chemically tempering the crystallized glass to be chemically tempered.

Now, the chemical tempering treatment will be described.

In the following, the crystallized glass to be chemically tempered to be subjected to the chemical tempering treatment may sometimes be referred to simply as a “glass plate”.

The chemical tempering treatment may be conducted by a known method. The chemical tempering treatment may be conducted for example by bringing the glass plate into contact with a molten metal salt (such as potassium nitrate or sodium nitrate) containing metal ions with a large ionic radius (typically K ions or Na ions). The glass plate and the molten metal salt are brought into contact with each other for example by soaking the glass plate in the molten metal salt.

By the contact of the glass plate with the metal salt, metal ions with a small ionic radius (typically Na ions or Li ions) in the glass plate are replaced with metal ions with a large ionic radius (typically K ions for the Na ions, and Na ions or K ions for Li ions).

The chemical tempering treatment, that is the ion exchange treatment, may be conducted for example by soaking the glass plate in a molten salt heated at 360 to 600° C. for 0.1 to 100 hours. The heating temperature for the molten salt is preferably 375° C. or higher, more preferably 415° C. or higher. The heating temperature for the molten salt is preferably 500° C. or lower, more preferably 470° C. or lower, particularly preferably 450° C. or lower. The time of soaking the glass plate in the molten salt is preferably 0.5 hours or more, more preferably 1 hour or more, further preferably 1.5 hours or more, particularly preferably 2 hours or more, most preferably 6 hours or more. The time of soaking the glass plate in the molten salt is preferably 100 hours or less, more preferably 50 hours or less, further preferably 20 hours or less.

The metal salt of the molten salt for conducting the chemical tempering treatment may, for example, be a nitrate, a sulfate, a carbonate or a chloride. The nitrate may, for example, be lithium nitrate, sodium nitrate, potassium nitrate, cesium nitrate or silver nitrate. The sulfate may, for example, be lithium sulfate, sodium sulfate, potassium sulfate, cesium sulfate or silver sulfate. The carbonate may, for example, be lithium carbonate, sodium carbonate or potassium carbonate. The chloride may, for example, be lithium chloride, sodium chloride, potassium chloride, cesium chloride or silver chloride. Such metal salts may be used alone or in combination of two or more.

Particularly, sodium nitrate is preferably contained in the molten salt. The content of sodium nitrate in the molten salt may be 70 mass % or more, or may be 90 mass % or more. The content of sodium nitrate in the molten salt may be 100 mass %.

The chemical tempering treatment may be conducted one time, or may be conducted two or more times under two or more different conditions (multistage tempering). That is, the chemical tempering treatment may be conducted in a single stage, or may be conducted in two or more stages.

The chemical tempering treatment in two or more stages may be conducted, for example, by bringing the crystallized glass to be chemically tempered, containing Li, into contact with a molten metal salt containing at least Na ions (first molten salt) and then into contact with a molten metal salt containing at least K ions (second molten salt).

The first molten salt also preferably contains a metal salt containing Na ions and a metal salt containing K ions. In a case where the first molten salt contains a metal salt containing Na ions and a metal salt containing K ions, the content of the metal salt containing Na ions, to the total mass of the first molten salt is preferably 5 mass % or more, more preferably 10 mass % or more, further preferably 20 mass % or more, particularly preferably 40 mass % or more. Further, the first molten salt may consist solely of a metal salt containing Na ions.

Further, the second molten salt also preferably contains a metal salt containing K ions and a metal salt containing Li ions. The second molten salt may further contain a metal salt containing Na ions.

The chemical tempering treatment is conducted preferably in a single stage, whereby the chemically tempered crystallized glass of the present invention will readily be obtained. It is also preferred that the chemical tempering treatment is conducted in a single stage and the content of sodium nitrate in the molten salt is 90 mass % or more.

### [Durability of Antifouling Layer]

The chemically tempered crystallized glass of the present invention is also preferably as follows. On one side of the chemically tempered crystallized glass, an antifouling layer containing a fluorinated compound is formed, and rubber rubbing test is performed on the surface of the chemically tempered crystallized glass on which the antifouling layer is formed under a load of 9.8 N for 2500 cycles, and after the rubber rubbing test, the water contact angle is 80° or more.

The method of forming the antifouling layer, the rubber rubbing test method and the method of measuring the water contact angle after the test, are in accordance with the methods described in Examples.

The water contact angle after the rubber rubbing test of 80° or more indicates that the antifouling layer remains even after the rubber rubbing test and corresponds to high durability of the antifouling layer formed on the chemically tempered crystallized glass.

The water contact angle after the rubber rubbing test is more preferably 85° or more.

### [Application]

The chemically tempered crystallized glass of the present invention may be useful as a cover glass.

The cover glass is suitably used e.g. for the purpose of protecting the surface of displays, solar cell modules, etc.

Particularly, the chemically tempered crystallized glass of the present invention is useful as a cover glass to be used for mobile devices such as mobile phones, smartphones, personal digital assistants (PDA) and tablet devices. Further, it is useful also for non-mobile purposes, that is e.g. as a cover glass of display devices such as televisions (TV), personal computers (PC) and touch panels, a cover glass to be provided on the surface of solar cell modules, a building material such as an elevator wall surface, a wall surface (full screen display) of building constructions such as houses and buildings, and window glass, and for tabletops, and interior of e.g. automobiles and aircrafts, etc. It is also useful as a cover glass of the above articles. It may also be applicable to e.g. housings having a curved shape by bending process and bending forming.

### <Crystallized Glass to be Chemically Tempered>

The crystallized glass to be chemically tempered of the present invention is such that the absolute value of the maximum voltage measured is 1200 V or more when corona discharge is generated under a voltage applied of 10 kV and the crystallized glass to be chemically tempered is charged for 30 seconds, measured by a static honest meter.

Measurement of the maximum voltage is the same as described for the maximum voltage of the chemically tempered crystallized glass of the present invention, and the description is omitted.

As described for the chemically tempered crystallized glass of the present invention, a high absolute value of the maximum voltage measured indicates that the crystallized glass to be chemically tempered tends to have a higher surface resistance. That is, the crystallized glass to be chemically tempered of the present invention is novel glass with a high surface resistance.

The crystallized glass to be chemically tempered of the present invention is suitably used for production of the above chemically tempered crystallized glass of the present invention.

Now, the crystallized glass to be chemically tempered of the present invention will be described in detail below.

### [Composition]

The composition of the crystallized glass to be chemically tempered of the present invention will be described. Hereinafter, a preferred composition of the crystallized glass to be chemically tempered may sometimes be referred to as the “base glass composition”.

The preferred composition of the crystallized glass to be chemically tempered of the present invention (base glass composition) comprises as represented by mole percentage based on oxides:
SiO₂: 60 to 75%,
Al₂O₃: 3 to 20%,
P₂O₅: 0 to 5%,
Li₂O: 6 to 23%,
Na₂O: 0 to 5%,
K₂O: 0 to 5%,
MgO: 0 to 10%,
CaO: 0 to 5%, and
ZrO₂: 0 to 5%.

Now, the respective components contained in the base glass composition will be described below.

SiO₂ is a glass network former. It is also a component to increase the chemical durability and to reduce formation of cracks when the glass surface is scarred.

The SiO₂ content is, for the purpose of improving chemical durability, more preferably 63% or more, further preferably 65% or more. With a view to achieving favorable melting properties, the SiO₂ content is more preferably 74.0% or less, further preferably 72.0% or less.

Al₂O₃ is a component to improve ion exchange performance at the time of chemical tempering and to increase the surface compressive stress after tempering. It also contributes to formation of a crystal containing Al and Li.

With a view to achieving the above effects, the Al₂O₃ content is more preferably 3.5% or more, further preferably 4.0% or more, still more preferably 4.5% or more. Further, less growth of crystals during melting, less occurrence of devitrification thus leading to a higher yield, and reduced high temperature viscosity of the glass thus leading to easy melting, may be required in some cases. From such viewpoint, the Al₂O₃ content is more preferably 18.0% or less, still more preferably 15.0% or less, even more preferably 12.0% or less, yet more preferably 9.0% or less, further preferably 7.0% or less, particularly preferably 6.0% or less.

SiO₂ and Al₂O₃ are both components to stabilize the structure of the glass. In order to reduce brittleness, the total content of SiO₂ and Al₂O₃ is preferably 64.0% or more, more preferably 66.0% or more, further preferably 68.0% or more.

Further, both SiO₂ and Al₂O₃ tend to increase the glass melting temperature. Thus, in order that the glass will be more easily melted, the total content of SiO₂ and Al₂O₃ is preferably 80.0% or less, more preferably 78.0% or less, further preferably 76.0% or less, particularly preferably 74.0% or less.

Li₂O is a component capable of ion exchange and is a component to improve glass melting property. By the glass containing Li₂O, such a stress profile is likely to be obtained that the surface compressive stress is high and the compressive stress layer is thick, by a method such that Li ions on the glass surface are ion-exchanged with external Na ions and included inside the glass, and the included Na ions are ion-exchanged with external K ions. Further, by the glass containing Li₂O within the above range, crystallized glass will readily be obtained when specific heat treatment is conducted. From such viewpoint, the Li₂O content is more preferably 15% or more, still more preferably 18% or more, yet more preferably 20% or more, further preferably 21% or more.

On the other hand, with a view to lowering the crystal growth rate during glass forming and to preventing quality deterioration due to devitrification, the Li₂O content is more preferably 22% or less.

Na₂O and K₂O are components to improve glass melting property and to reduce the crystal growth rate during glass forming. They are preferably contained in small amounts also in order to improve ion exchange performance.

Na₂O is a component capable of ion exchange in the chemical tempering treatment using a potassium salt and is a component to reduce the viscosity of the glass. In order to achieve such effects, the Na₂O content is preferably 0.3% or more, more preferably 0.5% or more, sill more preferably 0.8% or more, even more preferably 1.0% or more, yet more preferably 1.2% or more, further preferably 1.5% or more, particularly preferably 1.8% or more. On the other hand, with a view to maintaining the glass network and to preventing a reduction in the surface compressive stress (Na_CS) in the tempering treatment with a sodium salt, the Na₂O content is preferably 3.0% or less, more preferably 2.5% or less, further preferably 2.3% or less.

K₂O is a component to suppress an increase of the devitrification temperature thereby to prevent devitrification, and to improve ion exchange performance. The K₂O content is more preferably 0.03% or more, further preferably 0.05% or more, particularly preferably 0.1% or more.

On the other hand, with a view to preventing a reduction in the surface compressive stress (K_CS) in the tempering treatment with a sodium salt, the K₂O content is preferably 1.0% or less, more preferably 0.8% or less, further preferably 0.5% or less.

K₂O may not substantially be contained.

R, that is the total content of Li₂O, Na₂O and K₂O, is preferably 10 to 30%, more preferably 15 to 28%, particularly preferably 18 to 25%, with a view to suppressing an increase of the devitrification temperature and to reducing the crystal growth rate.

The ratio of the Li₂O content to R, that is [Li₂O]/([Li₂O]+[Na₂O]+[K₂O] (hereinafter sometimes referred to as “Li₂O/R₂O”), is preferably 0.88 or more, more preferably 0.90 or more, with a view to further improving the deep stress among the chemical tempering properties. With a view to further increasing the electrical resistance of the glass and to further improving the chemical resistance, Li₂O/R₂O is more preferably 0.99 or less, further preferably 0.98 or less, particularly preferably 0.95 or less.

The ratio of the Na₂O content to R, that is [Na₂O]/([Li₂O]+[Na₂O]+[K₂O](hereinafter sometimes referred to as “Na₂O/R₂O”), is preferably more than 0, more preferably 0.01 or more, further preferably 0.02 or more, particularly preferably 0.05 or more, most preferably 0.06 or more, with a view to further improving the deep stress among the chemical tempering properties. With a view to further increasing the chemical resistance, Na₂O/R₂O is preferably 0.40 or less, more preferably 0.30 or less, further preferably 0.20 or less, particularly preferably 0.10 or less.

The ratio of the K₂O content to R, that is [K₂O]/([Li₂O]+[Na₂O]+[K₂O] (hereinafter sometimes referred to as “K₂O/R₂O”), is preferably 0.001 or more, more preferably 0.004 or more, further preferably 0.01 or more, with a view to further increasing the electrical resistance of the glass. With a view to increasing the compressive stress in the vicinity of the surface among the chemical tempering properties, K₂O/R₂O is preferably 0.50 or less, more preferably 0.40 or less, further preferably 0.30 or less, particularly preferably 0.20 or less.

K₂O/R₂O may be 0.

Further, the product of Li₂O/R₂O, Na₂O/R₂O and K₂O/R₂O is preferably 0.00005 or more, more preferably 0.0001 or more, particularly preferably 0.01 or more, with a view to suppressing an increase of the devitrification temperature and to reducing the crystal growth rate. The product is preferably 0.020 or less.

The product may be 0.

The ratio of the Al₂O₃ content to R, that is [Al₂O₃]/([Li₂O]+[Na₂O]+[K₂O] (hereinafter sometimes referred to as “Al₂O₃/R₂O”), is preferably 0.05 or more, more preferably 0.10 or more, still more preferably 0.15 or more, further preferably 0.20 or more. Al₂O₃/R₂O is preferably 0.50 or less, more preferably 0.40 or less, further preferably 0.30 or less, particularly preferably 0.25 or less.

The value represented by [Al₂O₃]−[Na₂O]−[K₂O]+[Li₂O] is preferably 15.0% or more, more preferably 20.0% or more. The value is preferably 35.0% or less, more preferably 30.0% or less.

MgO may be contained e.g. in order to reduce the viscosity at the time of melting. The MgO content is preferably 0.05% or more, more preferably 0.5% or more, still more preferably 1.0% or more, even more preferably 2.0% or more, yet more preferably 3.0% or more, further preferably 4.0% or more.

On the other hand, in order that the compressive stress layer becomes thick at the time of the chemical tempering treatment, the MgO content is preferably 9.0% or less, more preferably 8.0% or less, still more preferably 7.0% or less, further preferably 6.0% or less.

By the glass containing MgO, crystal phase transfer from β-quartz solid solution to β-spodumene can be suppressed, and precipitation of β-spodumene crystals can be suppressed. Thus, the crystallized glass to be chemically tempered preferably contains MgO. From the above viewpoint, MgO is preferably contained in a content of more than 0.5% and 7.0% or less. The more preferred content is as described above.

MgO may not substantially be contained.

CaO is a component to improve the glass melting property and may be contained. The CaO content is preferably 0.005% or more, more preferably 0.01% or more. On the other hand, in order that the compressive stress becomes high at the time of the chemical tempering treatment, the CaO content is preferably 2.0% or less, more preferably 1.0% or less, particularly preferably 0.8% or less, most preferably 0.5% or less.

CaO may not substantially be contained.

In order to increase the stability of the glass, it is preferred that at least one of MgO and CaO is contained, and it is more preferred that MgO is contained. The total content of MgO and CaO is preferably 0.01% or more, more preferably more than 1.0%, further preferably 2.0% or more, particularly preferably 3.0% or more, most preferably 4.0% or more. With a view to further improving the chemical tempering properties, the total content of MgO and CaO is preferably 10.0% or less, more preferably 8.0% or less, still more preferably 7.0% or less, further preferably 6.0% or less.

SrO is a component to improve the glass melting properties and may be contained. The SrO content is preferably 0.1% or more, more preferably 0.15% or more, particularly preferably 0.5% or more.

In order to achieve a high compressive stress at the time of the chemical tempering treatment, the SrO content is preferably 3.0% or less, more preferably 2.0% or less, particularly preferably 1.0% or less, most preferably 0.5% or less.

SrO may not substantially be contained.

BaO is a component to improve the glass melting properties and may be contained. The content of BaO if contained is preferably 0.1% or more, more preferably 0.15% or more, further preferably 0.5% or more.

In order to achieve a high compressive stress at the time of the chemical tempering treatment, the BaO content is preferably 3.0% or less, more preferably 2.0% or less, further preferably 1.0% or less, particularly preferably 0.5% or less.

BaO may not substantially be contained.

ZnO is a component to improve the glass melting properties. The ZnO content is preferably 0.1% or more, more preferably 0.15% or more, particularly preferably 0.5% or more.

In order to achieve a high compressive stress at the time of the chemical tempering treatment, the ZnO content is preferably 3.0% or less, more preferably 2.0% or less, particularly preferably 1.0% or less, most preferably 0.5% or less.

ZnO may not substantially be contained.

InW is a parameter indicating the degree of mixing of oxides, calculated from the contents of alkali metal oxides, alkaline earth metal oxides and zinc oxide contained in the glass. InW is represented by the following formula.

$$formula ( W 1 )$$

$$InW = In ( \text{} ( [ {Li}_{2} O ] + \text{} [ {Na}_{2} O ] + [ {K}_{2} O + [ MgO ] + [ CaO ] + [ SrO ] + [ BaO ] + [ ZnO ] ) ! \text{} / ( [ {Li}_{2} \text{} O ] ! \times \text{} [ {Na}_{2} O ] ! \times [ {K}_{2} O ] ! \times [ MgO ] ! \times [ CaO ] ! \times [ SrO ] ! \times [ BaO ] ! \times [ ZnO ] ! ) )$$

In the formula (W1), [Li₂O], [Na₂O], [K₂O], [MgO], [CaO], [SrO], [BaO] and [ZnO] respectively represent contents of Li₂O, Na₂O, K₂O, MgO, CaO, SrO, BaO and ZnO as represented by mole percentage based on oxides.

! indicates the factorial of a positive integer. For example, [XO]! is a factorial of an integer obtained by truncating decimal places of the content of the component XO represented by mole percentage based on the oxide. For example, in a case where the content of Na₂O is 4.8 mol %, [Na₂O]! is a factorial of “4”, that is 4×3×2×1.

When the value of InW is high, the degree of mixing of the metal oxides is high and correspondingly devitrification of the glass can be suppressed. From the above viewpoint, InW is preferably 10 or more, more preferably 12 or more, further preferably 13 or more, particularly preferably 14 or more. InW is preferably 20 or less, more preferably 18 or less, further preferably 17 or less.

TiO₂ is a component having a high effect to suppress solarization of the glass and is a material to form crystal nuclei and thus may be contained. The content of TiO₂ if contained, is preferably 0.05% or more, more preferably 0.1% or more, further preferably 0.2% or more, particularly preferably 0.5% or more, most preferably 0.8% or more.

On the other hand, TiO₂ has light absorption property and thus with a view to preventing color development of the glass, the TiO₂ content is preferably 2.5% or less, more preferably 2.0% or less, further preferably 1.5% or less, particularly preferably 1.0% or less.

TiO₂ may not substantially be contained.

ZrO₂ is a component that helps the chemically tempered crystallized glass to have an increased surface compressive stress. It is also a material to form crystal nuclei and thus may be contained. The ZrO₂ content is more preferably more than 0%, still more preferably 0.5% or more, even more preferably 1% or more, yet more preferably 1.5% or more, further preferably 2% or more, particularly preferably 2.5% or more. The ZrO₂ content is preferably 4% or less.

P₂O₅ helps to increase the compressive stress layer at the time of chemical tempering. The P₂O₅ content is preferably 0.5% or more, more preferably 1.0% or more, particularly preferably 2.0% or more.

On the other hand, with a view to increasing acid resistance, the P₂O₅ content is preferably 3.0% or less. With a view to preventing generation of striae at the time of melting, it is also preferred that substantially no P₂O₅ is contained.

B₂O₃ reduces brittleness of the glass and improves crack resistance, and improves glass melting properties. The B₂O₃ content is preferably 0.5% or more, more preferably 1.0% or more, further preferably 2.0% or more.

On the other hand, with a view to keeping favorable acid resistance, the B₂O₃ content is preferably 8.0% or less, more preferably 6.0% or less, further preferably 4.0% or less, particularly preferably 2.0% or less. With a view to preventing generation of striae at the time of melting, it is also preferred that substantially no B₂O₃ is contained.

Y₂O₃ is a component to reduce the crystal growth rate while increasing the surface compressive stress of the chemically tempered crystallized glass. The Y₂O₃ content is preferably more than 0% and is more preferably 0.1% or more, still more preferably 0.2% or more, even more preferably 0.5% or more, further preferably 0.8% or more. On the other hand, with a view to increasing the compressive stress layer at the time of the chemical tempering treatment, the Y₂O₃ content is preferably 2.0% or less, more preferably 1.5% or less.

With a view to improving the initial melting properties, the total content of ZrO₂ and Y₂O₃ content is preferably 5.0% or less. The lower limit of the total content of ZrO₂ and Y₂O₃ is not particularly limited but with a view to increasing the glass strength, it is preferably 0.5% or more, more preferably 1.0% or more, still more preferably 1.5% or more, even more preferably 2.0% or more, yet more preferably 2.5% or more, further preferably 3.0% or more.

The ratio of the ZrO₂ content to the total content of ZrO₂ and Y₂O₃, that is [ZrO₂]/([ZrO₂]+[Y₂O₃], is preferably 0.50 or more, more preferably 1.00 or more, particularly preferably 2.00 or more. [ZrO₂]/([ZrO₂]+[Y₂O₃]) is preferably 8.00 or less, more preferably 7.00 or less, particularly preferably 6.00 or less.

ZrO₂ and Y₂O₃ are known as a nucleus-forming agent when added singly, and combined addition of ZrO₂ and Y₂O₃ forms an eutectic crystal of ZrO₂ and Y₂O₃. Thus, they can control the devitrification temperature, the crystal growth rate and the crystallization starting temperature.

Further, when [ZrO₂]/([ZrO₂]+[Y₂O₃]) is within the above range, diffusion of ions in the glass is suppressed and an increase of the devitrification temperature is suppressed, and thus devitrification can be suppressed.

When [ZrO₂]/([ZrO₂]+[Y₂O₃]) is within the above range, the glass will be stabilized. Further, the temperature range in which nucleus formation occurs and the temperature range in which the crystal growth occurs do not overlap and are separated, and resultingly an increase of the crystal growth rate is suppressed. Thus, occurrence of defects can be suppressed. Further, when [ZrO₂]/([ZrO₂]+[Y₂O₃]) is within the above range, the temperature range in which nucleus formation occurs shifts toward the low temperature side and a reduction of the crystallization starting temperature is suppressed, whereby the production properties will improve.

La₂O₃ is not essential but may be contained for the same reasons as those of Y₂O₃. The La₂O₃ content is preferably 0.1% or more, more preferably 0.2% or more, further preferably 0.5% or more, particularly preferably 0.8% or more. On the other hand, if its content is too high, the compressive stress layer will hardly be thick at the time of the chemical tempering treatment, and thus the La₂O₃ content is preferably 5.0% or less, more preferably 3.0% or less, further preferably 2.0% or less, particularly preferably 1.5% or less.

It is also preferred that substantially no La₂O₃ is contained.

Nb₂O₅, Ta₂O₅, Gd₂O₃ and CeO₂ have effects to suppress solarization of the glass and improve the melting property and thus may be contained. Their respective contents if contained are preferably 0.03% or more, more preferably 0.1% or more, further preferably 0.5% or more, particularly preferably 0.8% or more, most preferably 1.0% or more. On the other hand, they are preferably 3.0% or less, more preferably 2.0% or less, further preferably 1.0% or less.

Fe₂O₃, that absorbs heat rays, has an effect to improve the glass melting property, and is preferably contained in a case where the glass is to be produced in a large mass by a large-sized melting furnace. In such a case, its content is, as represented by mass % based on the oxide, preferably 0.002% or more, more preferably 0.005% or more, further preferably 0.007% or more, particularly preferably 0.01% or more. On the other hand, if Fe₂O₃ is contained in excess, the glass may be colored, and thus the Fe₂O₃ content is, with a view to increasing glass transparency, as represented by mass % based on the oxide, preferably 0.3% or less, more preferably 0.04% or less, further preferably 0.025% or less, particularly preferably 0.015% or less.

Further, within a range not to impair achievement of the desired chemical tempering properties, other coloring components may be added. Other coloring components may, for example, be suitably Co₃O₄, MnO₂, NiO, CuO, Cr₂O₃, V₂O₅, Bi₂O₃, SeO₂, Er₂O₃ and Nd₂O₃.

As e.g. a refining agent at the time of melting the glass, SO₃, a chloride, a fluoride, etc. may properly be contained. It is preferred that As₂O₃ is not contained. In a case where Sb₂O₃ is contained, its content is preferably 0.3% or less, more preferably 0.1% or less, and most preferably it is not contained.

With a view to fining the glass, the SnO₂ content is preferably 0.1% or more, more preferably, more preferably 0.2% or more, particularly preferably 0.3% or more. Further, in order to suppress occurrence of defects, the SnO₂ content is preferably 1% or less, more preferably 0.8% or less, further preferably 0.7% or less, particularly preferably 0.5% or less.

The crystallized glass to be chemically tempered of the present invention contains a crystal. The type of the crystal contained is not particularly limited and for example, the crystal is preferably at least one crystal selected from the group consisting of a lithium silicate crystal, a lithium aluminosilicate crystal and a lithium phosphate crystal. The lithium silicate crystal is preferably a lithium metasilicate (Li₂SiO₃) crystal, a lithium disilicate (Li₂Si₂O₅) crystal or the like. The lithium phosphate crystal is preferably a lithium orthophosphate (LisPO₄) crystal or the like. The lithium aluminosilicate crystal is preferably a β-spodumene (LiAlSi₂O₆) crystal, a petalite (LiAISi₄O₁₀) crystal or the like. Particularly, the crystal glass to be chemically tempered of the present invention preferably contains a crystal selected from the group consisting of LisPO₄, Li₂SiO₃, Li₂Si₂O₅, LiAlSi₄O₁₀ and LiAlSi₂O₆ crystals.

The degree of crystallization of the crystallized glass to be chemically tempered is preferably 10% or more, more preferably 15% or more, further preferably 20% or more, particularly preferably 25% or more, with a view to improving the mechanical strength. Further, in order to increase the transparency, it is preferably 70% or less, more preferably 60% or less, further preferably 50% or less. A low degree of crystallization is preferred also with a view to easily conducting bending forming with heating. The degree of crystallization may be calculated from X-ray diffraction intensity by Rietveld analysis. The Rietveld analysis is described in “Crystal Analysis Handbook”, edited by “Crystal Analysis Handbook” Editorial Committee, The Crystallographic Society of Japan (KYORITSU SHUPPAN CO., LTD., 1999, page 492 to 499).

The average particle size of precipitated crystals in the crystallized glass to be chemically tempered is preferably 300 nm or less, more preferably 200 nm or less, further preferably 150 nm or less, particularly preferably 100 nm or less, in order to achieve high transparency. The average particle size of the precipitated crystals may be obtained from a transmission electron microscope (TEM) image. Or, it may be estimated from a scanning electron microscope (SEM) image.

### [Physical Properties]

Now, preferred physical properties of the crystallized glass to be chemically tempered of the present invention will be described.

### (Devitrification Temperature)

The crystallized glass to be chemically tempered has a devitrification temperature of preferably 1300° C. or lower. The devitrification temperature is more preferably 1280° C. or lower, still more preferably 1250° C. or lower. It is even more preferably 1240° C. or lower, yet more preferably 1230° C. or lower, further preferably 1220° C. or lower, most preferably 1210° C. or lower. The lower limit of the devitrification temperature is not particularly limited and is usually 1100° C. or higher.

### (Glass Transition Point Tg, Crystallization Starting Temperature Tcs, Crystallization Peak Temperature Tc)

The crystallized glass to be chemically tempered (for example glass having the base glass composition) has a crystallization starting temperature Tcs as measured by DCS of preferably 500° C. or higher. The upper limit of the crystallization starting temperature is not particularly limited and is usually 800° C. or lower.

When the crystallization starting temperature Tcs is within the above range, by conducing heat treatment of, for example, holding a glass block or plate glass that has not been crystallized at 500 to 600° C. for 1 to 6 hours and then holding it at 600 to 800° C. for 0.5 to 6 hours, it is possible to precipitate crystals in the glass and crystallized glass to be chemically tempered, which is crystallized glass, can be obtained.

The heat treatment may be conducted in three steps. For example, the glass raw material mixture is held at 500 to 600° C. for 1 to 6 hours, held at 550 to 650° C. for 0.5 to 6 hours and held at 600 to 800° C. for 0.5 to 6 hours to obtain the crystallized glass to be chemically tempered.

The glass transition point Tg is preferably 500° C. or higher, more preferably 520° C. or higher, further preferably 540° C. or higher, with a view to suppressing warpage after the chemical tempering. With a view to easily conducting float process, it is preferably 750° C. or lower, more preferably 700° C. or lower, further preferably 650° C. or lower, particularly preferably 600° C. or lower, most preferably 580° C. or lower.

The crystallized glass to be chemically tempered having the base glass composition has a crystallization peak temperature Tc of preferably 600° C. or higher, more preferably 650° C. or higher, further preferably 700° C. or higher. By the crystallized glass to be chemically tempered having a crystallization peak temperature Tc of 600° C. or higher, it can be formed stably. It is most preferred that no crystallization peak is confirmed. The upper limit of the crystallization peak temperature Tc is not particularly limited and is usually 950° C. or lower.

The crystallized glass to be chemically tempered has a β-OH value of preferably 0.1 mm-1 or more, more preferably 0.15 mm-1 or more, further preferably 0.2 mm-1 or more, particularly preferably 0.22 mm-1 or more, most preferably 0.25 mm-1 or more.

The β-OH value is an index of the moisture content in the glass. Glass having a high β-OH value tends to have a low softening point and to be easily bent. On the other hand, with a view to improving the strength of the glass by chemical tempering, if the glass has a high β-OH value, the surface compressive stress (CS) after the chemical tempering treatment tends to be low. From such viewpoint, the β-OH value is preferably 0.5 mm⁻¹ or less, more preferably 0.4 mm⁻¹ or less, further preferably 0.3 mm⁻¹ or less.

The crystallized glass to be chemically tempered has a fracture toughness (K_{IC}) of preferably 0.80 MPa·m^{1/2} or more, more preferably 0.85 MPa·m^{1/2} or more, further preferably 0.90 MPa·m^{1/2} or more, particularly preferably 1.0 MPa·m^{1/2} or more, most preferably 1.1 MPa·m^{1/2} or more. The upper limit of the fracture toughness is not particularly limited and is typically 1.6 MPa·m^{1/2} or less.

The crystallized glass to be chemically tempered has a Young's modulus of preferably 80 GPa or more, more preferably 85 GPa or more, further preferably 90 GPa or more, particularly preferably 95 GPa or more, most preferably 100 GPa or more. The upper limit of the Young's modulus is not particularly limited and is typically 120 GPa or less.

The Young's modulus of the crystallized glass to be chemically tempered may be measured in accordance with Examples described later.

### [Production Method]

The crystallized glass to be chemically tempered of the present invention may be obtained, for example, by mixing and heating raw materials to achieve the above base glass composition, pouring the obtained molten glass into a mold, followed by cooling to room temperature to obtain a glass block, cutting and grinding the glass block to obtain plate glass, and conducting heat treatment on the glass block or the plate glass at a predetermined temperature. Crystals are precipitated by the heat treatment.

Heat treatment conditions may properly be adjusted e.g. the crystallization starting temperature Tcs of the base glass composition and for example, heat treatment under the following conditions is preferred.

As preferred heat treatment conditions, the glass raw material mixture is held at 500 to 650° C. for 1 to 6 hours and then held at 600 to 800° C. for 0.5 to 6 hours. As more preferred heat treatment conditions, the glass raw material mixture is held at 500 to 600° C. for 1.5 to 4.5 hours and then held at 620 to 740° C. for 1.5 to 4.5 hours.

### Examples

Now, the present invention will be described in further detail with reference to Examples.

The materials, the amounts of use, the proportions, the treatment details, the treatment procedures, etc. described in the following Examples may properly be modified within the scope of the present invention. Thus, it should be understood that the present invention by no means restricted to the following Examples.

Ex. 4 to 12 are Examples relating to chemically tempered crystallized glass, and Ex. 1 to 3, 13 and 14 are Comparative Examples relating to the chemically tempered crystallized glass.

Ex. 15 and 17 are Examples relating to crystallized glass to be chemically tempered, and Ex. 16 is a Comparative Example relating to the crystallized glass to be chemically tempered.

### <Preparation of Chemically Tempered Crystallized Glass>

First, glass raw materials that would achieve each glass composition as represented by mole percentage based on oxides, as identified in Table 1 were melted in a platinum crucible to prepare glass materials A′ and B′.

Specifically, as oxides, hydroxides, carbonates, nitrates and the like to be used as the glass raw materials, commonly used glass raw materials were properly selected, weighed so that the weight of the glass would be 1000 g and mixed.

Then, the raw material mixture was put in a platinum crucible, placed in an electrical resistance furnace at 1500 to 1700° C. and melted over a period of about 3 hours to remove bubbles and homogenize the mixture to obtain molten glass. The molten glass was poured into a mold and held at a temperature of the glass transition point+50° C. for 1 hour and then cooled at a rate of 0.5° C./min to room temperature thereby to obtain a glass block. The obtained glass block was cut and ground to obtain plate glass.

Regarding the glass material A′, the plate glass obtained was subjected to heat treatment of heating the glass to 550° C. and holding it for 2 hours and then heating the glass to 720° C. and holding it for 2 hours to obtain glass material A.

Regarding the glass material B′, the plate glass obtained was subjected to heat treatment of heating the glass to 550° C. and holding it for 4 hours and then heating the glass to 660° C. and holding it for 4 hours to obtain glass material B.

Both surfaces of the obtained plate glass were mirror-polished to finally obtain plate glass (glass to be chemically tempered) of 120 mm×60 mm×0.55 mm in thickness or 120 mm×60 mm×0.7 mm in thickness.

Regarding the glass materials A′ and B′, each glass block was subjected to the same heat treatment as above to obtain a sample piece for fracture toughness (K_{IC}) measurement and a sample piece for Young's modulus measurement.

Each of the above obtained glasses to be chemically tempered (glass materials A and B) was subjected to chemical tempering treatment under conditions as identified in Table 2 to obtain chemically tempered glass in each of Ex. 1 to 14. Each of the glass materials A and B is crystallized glass to be chemically tempered.

The glass to be chemically tempered in each of Ex. 15 to 17 was obtained by conducting the heat treatment under conditions as identified in Table 3.

### <Measurement of Stress Profile>

The stress profile of the chemically tempered glass was obtained by the above described method.

### <Measurement of Young's Modulus>

Using the sample pieces cut out in the process of obtaining each glass material, the Young's modulus of the glass to be chemically tempered was measured. Specifically, the Young's modulus was measured by using the sample pieces by ultrasonic pulse technique in accordance with JIS R1602.

The Young's modulus measured in the same manner after the chemical tempering was the same as the Young's modulus before the chemical tempering.

### <Measurement of Fracture Toughness>

Using the sample pieces cut out in the process of obtaining each glass material, the fracture toughness K_{IC} of the glass to be chemically tempered was measured. The fracture toughness was measured by the above described DCDC method.

The fracture toughness K_{IC} measured in the same manner after the chemical tempering was the same as the fracture toughness K_{IC} before the chemical tempering.

### <Antifouling Layer Durability Test>

An antifouling layer was formed on the surface of the chemically tempered glass in each Ex., and the formed antifouling layer was subjected to durability test.

More specifically, the chemically tempered glass was cut into a 5 cm square sample, an antifouling layer was formed on the chemically tempered glass and rubber rubbing test was conducted by the following procedure, and then the water contact angle was measured.

First, the chemically tempered glass washed with water was subjected to plasma cleaning, an organic compound containing fluorine (UD-509 manufactured by DAIKIN INDUSTRIES, LTD.) was deposited on the chemically tempered glass by vacuum deposition to form an antifouling layer. The pressure of the vacuum chamber at the time of forming the layer was 3.0×10−3 Pa. The organic compound was heated by electric resistance and deposited for 300 seconds at an output of 318.5 kA/m².

Then, rubber rubbing test was conducted as follows on the surface of the chemically tempered glass on which the antifouling layer was formed.

Specifically, using a plane abrasion tester (number of specimen: 3) (manufactured by DAIEI KAGAKU SEIKI MFG. CO., LTD., apparatus name: PA-300A), rubber rubbing test was conducted under a load of 9.8 N with a rubbing finger (eraser (manufactured by WOOJIN, PINKPENCIL)) with a stroke length of 40 mm at 40 cycles/min for 2500 cycles. The test environment was at 25° C. under 50% RH.

After the rubber rubbing test, the water contact angle on the surface of the chemically tempered glass on which the antifouling layer was formed, was measured.

Specifically, about 1 μL of a water droplet was deposited on the surface of the chemically tempered glass, and the water contact angle) (° was measured by a contact angle meter.

The water contact angle on the surface of the antifouling layer is larger than the water contact angle of the chemically tempered glass before formation of the antifouling layer. Thus, a large water contact angle after the rubber rubbing test is considered to correspond to remaining of the formed antifouling layer in a larger amount.

### <Drop Height>

With respect to the chemically tempered glass in each Ex., the drop strength was evaluated as follows.

The chemically tempered glass in each Ex. was fixed to a structure having its mass and rigidity adjusted to those of a commonly used smartphone to prepare a pseudo smartphone. The pseudo smartphone was let fall freely from various heights on #80 SiC sand paper so that the side of the pseudo smartphone on which the chemically tempered glass was fixed faced the ground side. The pseudo smartphone was dropped from a height of 20 cm first. In a case where the chemically tempered glass was not broken after the pseudo smartphone was dropped from a height of 20 cm, then the pseudo smartphone was dropped from a height of 25 cm. In a case where the chemically tempered glass was not broken after the pseudo smartphone was dropped from a height of 25 cm, then the pseudo smartphone was dropped from a height of 30 cm. This operation of dropping the pseudo smartphone from a height higher by 5 cm than the previous dropping, in a case where the pseudo smartphone was not broken after the previous dropping, was repeated, until the chemically tempered glass was broken. The height from which the chemically tempered glass was broken for the first time was taken as the drop height.

The drop height was measured with respect to 19 pieces of the chemically tempered glass and the arithmetic mean of the drop heights was taken as the drop height and is shown in Table described later.

The higher value of the drop height corresponds to resistance to breakage of the chemically tempered glass even when dropped from a higher place, that is, the chemically tempered glass has a greater drop resistance.

### <Results>

The composition of the chemically tempered glass subjected to the chemical tempering treatment, the chemical tempering treatment conditions and the measurement results in each Ex. were shown in the following Tables 1 to 3.

In Tables 2 and 3, the maximum voltage measured was one measured by the above method. In Tables 2 and 3, the absolute value of the maximum voltage measured is shown.

In Table 2, the Young's modulus and K_{IC} (fracture toughness) are values measured by the above method using the sample pieces for measurement.

In Table 2, items in the stress profile row are as follows. The respective values are calculated as decried above or as follows.
CS₅₀ and CS₉₀: the compressive stress at each depth (unit: μm) of the obtained chemically tempered glass.
CS₀: the compressive stress at the surface of the chemically tempered glass
DOC: depth of compressive stress layer of the chemically tempered glass
“DOC” is typically a depth at which the compressive stress is 0 MPa in stress distribution obtained by using only a scattered light photoelectric stress meter.
CSₐᵣₑₐ: the product of the depth of compressive stress layer DOC and CS₀ of the chemically tempered glass.
CT_{Max}: the maximum value of the tensile stress.
CTₐᵥₑ: the average value of the tensile stress.
ICT: the integrated value of the tensile stress

TABLE 1

| | | |
|---|---|---|
| Glass material | A | B |

| | | | |
|---|---|---|---|
| Composition | SiO₂ | 61 | 71 |
| (mol %) | B₂O₃ | 0 | 0 |
| | Al₂O₃ | 5 | 4.5 |
| | P₂O₅ | 2 | 1 |
| | Y₂O₃ | 1 | 0 |
| | Li₂O | 21 | 21 |
| | Na₂O | 2 | 0.39 |
| | K₂O | 0 | 0.1 |
| | MgO | 5 | 0 |
| | CaO | 0 | 0.01 |
| | SrO | 0 | 0 |
| | ZnO | 0 | 0 |
| | ZrO₂ | 3 | 2 |
| | TiO₂ | 0 | 0 |
| | SnO₂ | 0 | 0 |
| | Fe₂O₃ | 0 | 0 |
| | SUM | 100.0 | 100.0 |

| | | |
|---|---|---|
| Type of crystal | Li₃PO₄ | LiAlSi₄O₁₀ |
| R = Li₂O + Na₂O + K₂O | 23 | 21.49 |
| a = Li₂O/R | 0.91 | 0.98 |
| b = Na₂O/R | 0.09 | 0.02 |
| c = K₂O/R | 0.00 | 0.005 |
| Q = Al₂O₃/R | 0.22 | 0.21 |
| S = a × b × c | 0.000 | 0.00008 |
| K_{IC} (MPa · m^{1/2}) | 0.88 | — |
| Young's modulus (GPa) | 95 | 108 |

TABLE 2

| | | | Ex. 1 | Ex. 2 | Ex. 3 | Ex. 4 |
|---|---|---|---|---|---|---|
| Glass material | | | A | A | A | A |
| Plate thickness | | (mm) | 0.7 | 0.7 | 0.7 | 0.7 |
| Crystallization conditions | | | 550° C. 2 h | 550° C. 2 h | 550° C. 2 h | 550° C. 2 h |
| | | | 720° C. 2 h | 720° C. 2 h | 720° C. 2 h | 720° C. 2 h |
| First ion | First molten salt | KNO₃ | 0 | 0 | 0 | 0 |
| exchange | composition (mass %) | NaNO₃ | 100 | 100 | 100 | 100 |
| | | LiNO₃ | 0 | 0 | 0 | 0 |
| | Temperature | (° C.) | 420 | 450 | 450 | 450 |
| | Time | (min) | 120 | 80 | 120 | 240 |
| Second | Second molten salt | KNO₃ | — | — | — | — |
| ion | composition (mass %) | NaNO₃ | — | — | — | — |
| exchange | | LiNO₃ | — | — | — | — |
| | Temperature | (° C.) | — | — | — | — |
| | Time | (min) | — | — | — | — |
| Stress | CS₀ | (MPa) | 580 | 600 | 633 | 539 |
| profile | DOC | (μm) | 95 | 110 | 120 | 147 |
| | CSₐᵣₑₐ | (Pa · m) | 55100 | 66000 | 75633 | 79118 |
| | CS₅₀ | (MPa) | 230 | 280 | 325 | 333 |
| | CS₉₀ | (MPa) | 18 | 80 | 111 | 177 |
| | CT_{Max} | (MPa) | 90 | 100 | 129 | 179 |
| | CTₐᵥₑ | (MPa) | 85 | 95 | 109 | 131 |
| | ICT | (Pa · m) | 43350 | 45600 | 50358 | 53396 |
| | Maximum voltage measured | (V) | 1905 | 1920 | 1937 | 2025 |
| | Water contact angle after | (°) | 105 | 103 | 100 | 89 |
| | test | | | | | |
| | Drop height | (cm) | 45 | 75 | 80 | 105 |

| | | | Ex. 5 | Ex. 6 | Ex. 7 |
|---|---|---|---|---|---|
| Glass material | | | A | A | A |
| Plate thickness | | (mm) | 0.7 | 0.7 | 0.7 |
| Crystallization conditions | | | 550° C. 2 h | 550° C. 2 h | 550° C. 2 h |
| | | | 720° C. 2 h | 720° C. 2 h | 720° C. 2 h |
| First ion | First molten salt | KNO₃ | 0 | 0 | 0 |
| exchange | composition (mass %) | NaNO₃ | 100 | 100 | 100 |
| | | LiNO₃ | 0 | 0 | 0 |
| | Temperature | (° C.) | 450 | 450 | 450 |
| | Time | (min) | 360 | 720 | 1080 |
| Second | Second molten salt | KNO₃ | — | — | — |
| ion | composition (mass %) | NaNO₃ | — | — | — |
| exchange | | LiNO₃ | — | — | — |
| | Temperature | (° C.) | — | — | — |
| | Time | (min) | — | — | — |
| Stress | CS₀ | (MPa) | 473 | 371 | 275 |
| profile | DOC | (μm) | 159 | 173 | 180 |
| | CSₐᵣₑₐ | (Pa · m) | 75104 | 64260 | 49368 |
| | CS₅₀ | (MPa) | 309 | 264 | 207 |
| | CS₉₀ | (MPa) | 183 | 177 | 149 |
| | CT_{Max} | (MPa) | 204 | 213 | 168 |
| | CTₐᵥₑ | (MPa) | 136 | 134 | 105 |
| | ICT | (Pa · m) | 52039 | 47483 | 35889 |
| | Maximum voltage measured | (V) | 2064 | 2055 | 1970 |
| | Water contact angle after | (°) | 83 | 86 | 90 |
| | test | | | | |
| | Drop height | (cm) | 110 | 105 | 95 |

| | | | Ex. 8 | Ex.9 | Ex. 10 |
|---|---|---|---|---|---|
| Glass material | | | B | B | B |
| Plate thickness | | (mm) | 0.7 | 0.7 | 0.7 |
| Crystallization conditions | | | 550° C. 4 h | 550° C. 4 h | 550° C. 4 h |
| | | | 660° C. 4 h | 660° C. 4 h | 660° C. 4 h |
| First ion | First molten salt | KNO₃ | 0 | 0 | 0 |
| exchange | composition (mass %) | NaNO₃ | 100 | 100 | 100 |
| | | LiNO₃ | 0 | 0 | 0 |
| | Temperature | (° C.) | 450 | 450 | 450 |
| | Time | (min) | 120 | 240 | 360 |
| Second | Second molten salt | KNO₃ | — | — | — |
| ion | composition (mass %) | NaNO₃ | — | — | — |
| exchange | | LiNO₃ | — | — | — |
| | Temperature | (° C.) | — | — | — |
| | Time | (min) | — | — | — |
| Stress | CS₀ | (MPa) | 226 | 207 | 176 |
| profile | DOC | (μm) | 83 | 105 | 118 |
| | CSₐᵣₑₐ | (Pa · m) | 18726 | 21687 | 20770 |
| | CS₅₀ | (MPa) | 73 | 98 | 96 |
| | CS₉₀ | (MPa) | −10 | 21 | 35 |
| | CT_{Max} | (MPa) | 42 | 57 | 61 |
| | CTₐᵥₑ | (MPa) | 38 | 49 | 50 |
| | ICT | (Pa · m) | 20225 | 24115 | 23032 |
| | Maximum voltage measured | (V) | 2070 | 2092 | 2107 |
| | Water contact angle after | (°) | 82 | 60 | 78 |
| | test | | | | |
| | Drop height | (cm) | 60 | 75 | 80 |

| | | | | Ex.11 | Ex. 12 |
|---|---|---|---|---|---|
| Glass material | | | | B | B |
| Plate thickness | | | (mm) | 0.7 | 0.7 |
| Crystallization conditions | | | | 550° C. 4 h | 550° C. 4 h |
| | | | | 660° C. 4 h | 660° C. 4 h |
| | First ion | First molten salt | KNO₃ | 0 | 0 |
| | exchange | composition (mass %) | NaNO₃ | 100 | 100 |
| | | | LiNO₃ | 0 | 0 |
| | | Temperature | (° C.) | 450 | 450 |
| | | Time | (min) | 720 | 1080 |
| | Second | Second molten salt | KNO₃ | — | — |
| | ion | composition (mass %) | NaNO₃ | — | — |
| | exchange | | LiNO₃ | — | — |
| | | Temperature | (° C.) | — | — |
| | | Time | (min) | — | — |
| | Stress | CS₀ | (MPa) | 174 | 156 |
| | profile | DOC | (μm) | 136 | 143 |
| | | CSₐᵣₑₐ | (Pa · m) | 23657 | 22217 |
| | | CS₅₀ | (MPa) | 104 | 98 |
| | | CS₉₀ | (MPa) | 51 | 53 |
| | | CT_{Max} | (MPa) | 88 | 98 |
| | | CTₐᵥₑ | (MPa) | 62 | 67 |
| | | ICT | (Pa · m) | 26617 | 27648 |
| | | Maximum voltage measured | (V) | 2143 | 2160 |
| | | Water contact angle after | (°) | 72 | 73 |
| | | test | | | |
| | | Drop height | (cm) | 86 | — |

| | | | Ex. 13 | Ex. 14 |
|---|---|---|---|---|
| Glass material | | | A | A |
| Plate thickness | | (mm) | 0.7 | 0.7 |
| Crystallization conditions | | | 550° C. 2 h | 550° C. 2 h |
| | | | 750° C. 2 h | 750° C. 2 h |
| First ion | First molten salt | KNO₃ | 0 | 80 |
| exchange | composition (mass %) | NaNO₃ | 100 | 20 |
| | | LiNO₃ | 0 | 0 |
| | Temperature | (° C.) | 390 | 410 |
| | Time | (min) | 330 | 300 |
| Second | Second molten salt | KNO₃ | 99.5 | 99.5 |
| ion | composition (mass %) | NaNO₃ | 0 | 0 |
| exchange | | LiNO₃ | 0.5 | 0.5 |
| | Temperature | (° C.) | 410 | 410 |
| | Time | (min) | 60 | 60 |
| Stress | CS₀ | (MPa) | 286 | 311 |
| profile | DOC | (μm) | 124 | 133 |
| | CSₐᵣₑₐ | (Pa · m) | 35464 | 41363 |
| | CS₅₀ | (MPa) | 218 | 230 |
| | CS₉₀ | (MPa) | 104 | 127 |
| | CT_{Max} | (MPa) | 85 | 100 |
| | CTₐᵥₑ | (MPa) | 75 | 87 |
| | ICT | (Pa · m) | 33900 | 37758 |
| | Maximum voltage measured | (V) | 1915 | 1935 |
| | Water contact angle after | (°) | 72 | 75 |
| | test | | | |
| | Drop height | (cm) | — | — |

TABLE 3

| | | Ex. 15 | Ex. 16 | Ex. 17 |
|---|---|---|---|---|
| Glass material | | A | A | B |
| Plate thickness | (mm) | 0.7 | 0.7 | 0.7 |
| Crystallization | | 550° C. 2 h | 550° C. 2 h | 550° C. 4 h |
| conditions | | 720° C. 2 h | 750° C. 2 h | 660° C. 4 h |
| Maximum voltage | (V) | 1293 | 1178 | 1358 |
| measured | | | | |

From the results shown in Table 2, it was confirmed that the chemically tempered glass in each of Ex. 4 to 12 is chemically tempered crystallized glass with a maximum voltage measured of 1950 V or more and is novel.

From the comparison between Ex. 4 to 8 and Ex. 9 to 12, it was confirmed that the antifouling layer formed on the surface of the chemically tempered crystallized glass with a maximum voltage measured of less than 2070 V, is excellent in durability.

From the results shown in Table 3, it was confirmed that the chemically tempered glass in each of Ex. 1 and 3 is crystallized glass to be chemically tempered with a maximum voltage measured of 1200 V or more and is novel.

The entire disclosure of Japanese Patent Application No. 2024-041329 filed on Mar. 15, 2024 including specification, claims, drawings and summary is incorporated herein by reference in its entirety.

What is claimed is:

1. Chemically tempered crystallized glass obtained by chemically tempering crystallized glass to be chemically tempered, wherein the absolute value of the maximum voltage measured is 1950 V or more when corona discharge is generated under a voltage applied of 10 KV and the chemically tempered crystallized glass is charged for 30 seconds, measured by a static honest meter.

2. The chemically tempered crystallized glass according to claim 1, wherein the crystallized glass to be chemically tempered has a composition as represented by mole percentage based on oxides comprising:
SiO₂: 60 to 75%,
Al₂O₃: 3 to 20%,
P₂O₅: 0 to 5%,
Li₂O: 6 to 23%,
Na₂O: 0 to 5%,
K₂O: 0 to 5%,
MgO: 0 to 10%,
CaO: 0 to 5%, and
ZrO₂: 0 to 5%.

3. The chemically tempered crystallized glass according to claim 1, which contains a crystal selected from the group consisting of Li₃PO₄, Li₂SiO₃, Li₂Si₂O₅, LiAlSi₄O₁₀ and LiAlSi₂O₆ crystals.

4. The chemically tempered crystallized glass according to claim 1, wherein the absolute value of the maximum voltage measured is 2250 V or less.

5. The chemically tempered crystallized glass according to claim 1, which has a fracture toughness K_{IC} of 0.90 MPa·m^{1/2} or more.

6. The chemically tempered crystallized glass according to claim 1, which has a Young's modulus of 85 GPa or more.

7. The chemically tempered crystallized glass according to claim 1, wherein the average value of the tensile stress CTₐᵥₑ of the crystallized glass to be chemically tempered is 95 MPa or more.

8. The chemically tempered crystallized glass according to claim 1, wherein the maximum value of the tensile stress CT_{Max} of the crystallized glass to be chemically tempered is 100 MPa or more.

9. The chemically tempered crystallized glass according to claim 1, which satisfies the following formula (I):
$$C {S}_{90} ≧ 0.2 t - 10 \qquad formula ( I )$$
in the formula (I), CS₉₀ is the compressive stress at a depth of 90 μm from the surface of the chemically tempered crystallized glass, where the unit is MPa; and
in the formula (I), t is the plate thickness of the chemically tempered crystallized glass, where the unit is μm.

10. The chemically tempered crystallized glass according to claim 1, wherein the depth of compressive stress layer DOC is 0.17 to 0.25 times the plate thickness of the chemically tempered crystallized glass, where the unit of the depth of compressive stress layer and the unit of the plate thickness of the chemically tempered crystallized glass are μm.

11. The chemically tempered crystallized glass according to claim 1, wherein the water contact angle is 80° or more, after an antifouling layer containing a fluorinated compound is formed on one side of the chemically tempered crystallized glass, and rubber rubbing test is conducted on the surface of the chemically tempered crystallized glass on which the antifouling layer is formed, under a load of 9.8N for 2500 cycles.

12. Crystallized glass to be chemically tempered, wherein the absolute value of the maximum voltage measured is 1200 V or more when corona discharge is generated under a voltage applied of 10 kV and the crystallized glass to be chemically tempered is charged for 30 seconds, measured by a static honest meter.

13. The crystallized glass to be chemically tempered according to claim 12, which has a composition as represented by mole percentage based on oxides comprising:
SiO₂: 60 to 75%,
Al₂O₃: 3 to 20%,
P₂O₅: 0 to 5%,
Li₂O: 6 to 23%,
Na₂O: 0 to 5%,
K₂O: 0 to 5%,
MgO: 0 to 10%,
CaO: 0 to 5%, and
ZrO₂: 0 to 5%.

14. The crystallized glass to be chemically tempered according to claim 12, which contains a crystal selected from the group consisting of Li₃PO₄, Li₂SiO₃, Li₂Si₂O₅, LiAlSi₄O₁₀ and LiAlSi₂O₆ crystals.

15. The crystallized glass to be chemically tempered according to claim 12, which has a fracture toughness K_{IC} of 0.90 MPa·m^{1/2} or more.

16. The crystallized glass to be chemically tempered according to claim 12, which has a Young's modulus of 85 GPa or more.
